(19) United States
(12) Patent Application Publication
(10) Pub. No.: US 2008/0169974 A1
(43) Pub. Date: Jul. 17, 2008

(54) Radar system

(75) Inventors: Takumi Fujikawa, Nishinomiya-City (JP); Takashi Inaoka, Nishinomiya-City (JP); Kouichi Kobayashi, Nishinomiya-City (JP)

Correspondence Address: EDWARDS ANGELL PALMER & DODGE LLP, P.O. BOX 55874, BOSTON, MA, 02205, US

(73) Assignee: Furuno Electric Company, Ltd., Nishinomiya-City (JP)

(21) Appl. No.: 11/900,709

(22) Filed: Sep. 13, 2007

(30) Foreign Application Priority Data
Sep. 13, 2006 (JP) 2006-248727

(51) Int. Cl. G01S 13/00

(52) U.S. Cl. 342/179

(57) ABSTRACT

A radar system configured to present plural echo signals in a mixed form includes an image mixer for determining display colors for individual radar image regions based on combinations of the levels of the echo signals obtained from the same locations. The image mixer classifies the combinations of the levels of the echo signals into a predetermined number of groups according to the number of the echo signals to be mixed and selects display colors for the individual groups as well as shades of each display color according to the levels of the echo signals to be mixed.

### BACKGROUND OF THE INVENTION

1. Field of the Invention

The present invention relates to a radar system which can present plural kinds of received signals in a mixed form on a single display.

2. Description of the Related Art

Generally, a radar apparatus transmits a radio wave and receives echoes reflected back from targets through an antenna. The radar apparatus determines angular direction, or bearing (θ), of a particular target from the direction of the antenna as well as a range (r) to the target based on the time elapsed from transmission of the radio wave to reception of the pertinent target echo.

While the radar apparatus works in essentially the same way as mentioned above, a radar picture presented by the radar apparatus can have varying appearances and qualities depending on such conditions as the frequency of the radio wave transmitted from the antenna, transmission pulselength, output power and antenna position (height), for instance.

Shipborne radar apparatuses operate in one of two frequency bands, that is, the X-band (9 GHz) and the S-band (3 GHz). Although an X-band radar employs a compact antenna, yet providing high bearing discrimination, the X-band is susceptible to the influence of sea clutter and would greatly attenuate under rainy or snowy conditions. On the other hand, an S-band radar requires a large-sized antenna to achieve a level of bearing discrimination equivalent to that of the X-band radar, however, the S-band is less susceptible to the influence of sea clutter and would not attenuate so much even under rainy or snowy conditions, so that the S-band is advantageous under bad weather conditions compared to the X-band.

Short and long transmission pulselengths have different characteristics with respect to target detecting capabilities. Specifically, short transmission pulselengths provide high range discrimination but poor long-range detectability as echoes from targets at long ranges are weak. Contrary to this, long transmission pulselengths provide lower range discrimination but improved long-range detectability.

Performance of the radar apparatus also varies with the height of a site where the antenna is installed. For example, if the installation site of the antenna is high, the radar apparatus provides increased long-range detectability. It is however known that the higher the antenna installation site, the more a range of sea clutter hindering target detection extends farther out from a sweep origin. On the other hand, while a minimum range at which the radar apparatus can detect a specified target is dependent on a vertical beamwidth, the lower the antenna installation site, the shorter the minimum range. Accordingly, it has conventionally been a common practice to install a plurality of radar apparatuses and selectively use one of radar pictures presented on individual displays units depending on observation purposes and circumstances.

One of recent developments in radar technology is a radar apparatus disclosed in Japanese Patent Application Publication No. 2000-206225. This radar apparatus is configured to alternately transmit signals having different pulselengths from a single antenna. According to the Publication, the radar apparatus can almost simultaneously obtain two or more radar pictures from the single antenna and selectively present one of the radar pictures depending on observation purposes and circumstances.

In addition, there exist conventionally known techniques for presenting plural kinds of received signals in a mixed form on a single display. Disclosed in below-described Japanese Patent Application Publication Nos. 1992-238285 and 1996-313617 are examples of such techniques.

The technique disclosed in Japanese Patent Application Publication No. 1992-238285 (as claimed in claim 2 at the time of application) enables generation of synthesized image data by performing a process of addition or averaging of digital image data on radar pictures obtained from a plurality of radar apparatuses. A radar system described in this Publication can present a synthesized radar picture generated from the radar pictures of the plurality of radar apparatuses having different target detecting capabilities by properly combining, or mixing, the image data obtained from the different radar apparatuses depending on the observation purposes and circumstances.

The technique disclosed in Japanese Patent Application Publication No. 1996-313617 is concerned with a multi-radar system including a plurality of land-based radar apparatuses for locating and tracking ships in specified surveillance areas and for providing navigation-related information, for example. A multiple radar image processing device of this Publication presents radar pictures obtained by the plurality of radar apparatuses in different colors. In regions where the surveillance areas of the multiple radar apparatuses overlap, the multiple radar image processing device presents the radar pictures in colored patterns. With this arrangement, the multiple radar image processing device makes it possible to distinguish between the radar pictures obtained by the individual radar apparatuses as well as the regions of synthesized radar pictures simultaneously obtained by more than one radar apparatus.

In the technique disclosed in Japanese Patent Application Publication No. 1992-238285, the image data on the plural radar pictures are added or averaged so that it is impossible to tell from which one of the plurality of radar apparatuses the radar picture displayed on-screen has been obtained. Provided that radar observations have been obtained with a pair of radar apparatuses A and B, for example, the radar observations obtained by the two radar apparatuses A, B are added up or averaged. A problem resulting from this processing is that it is impossible to tell whether a particular target echo displayed on-screen represents information derived from the radar apparatus A alone, information derived from the radar apparatus B alone, or information derived from both.

In the technique disclosed in Japanese Patent Application Publication No. 1996-313617, on the other hand, the multiple radar image processing device identifies each region where the surveillance areas of two adjacent radar apparatuses A, B overlap based on observation points (antenna positions) of the individual radar apparatuses. For this reason, it is possible to tell whether a particular region is observed by the radar apparatus A alone, the radar apparatus B alone, or both.

Although it is possible to identify a region observed by both the radar apparatuses A and B according to the technique of Japanese Patent Application Publication No. 1996-313617, there remains a problem that it is impossible to know levels of echo signals received by the two adjacent radar apparatuses A, B. Especially when mixing plural kinds of received echo signals obtained by varying such conditions as the transmitting frequency, transmission pulselength, output power and antenna position (height), for instance, to provide a radar operator with information suitable for the observation purposes and circumstances, it is extremely important to enable the radar operator to know exact signal intensities of target echoes obtained from the individual kinds of received echo signals.

### SUMMARY OF THE INVENTION

In light of the foregoing, it is an object of the invention to provide a radar system which can present a combination of radar pictures obtained from plural kinds of received echo signals on a single display, the radar system having a capability to present a radar picture obtained from a combination of the plural kinds of echo signals together with information on intensities of the individual echo signals in a manner that permits a radar operator to distinguish each of the radar pictures obtained from the different echo signals.

According to a principal feature of the invention, a radar system configured to present plural echo signals in a mixed form includes an image mixer for determining display colors for individual radar image regions based on combinations of the levels of the echo signals obtained from the same locations. Specifically, the image mixer of the radar system of the invention does not select the display colors in one-to-one correspondence with results of mixing of the plural echo signals but selects the display colors based on the combinations of the levels of the plural echo signals. This approach makes it possible to vary on-screen display colors and shades of each display color according to the levels of the individual echo signals, so that the radar system can present a radar picture in any display colors suited to observation. In a case where one of the echo signals to be mixed is not obtained due to a difference in detection range, for instance, that echo signal may be regarded as being at zero level and combined with the other echo signal(s) in determining the display colors for the individual radar image regions.

One specific example of operation to be performed by the image mixer is classify the combinations of the levels of the echo signals into a predetermined number of groups according to the number of the echo signals to be mixed and select display colors for the individual groups as well as shades of each display color according to the levels of the echo signals to be mixed. With this operation, it is possible to distinguish between different groups based on the display colors of the individual radar image regions. Provided that the number of echo signals to be mixed is m (which is an integer larger than 1), the total number of groups into which the image mixer classifies the combinations of the echo signal levels may be 2^{m}.

In one feature of the invention, the radar system further includes first image memories for storing the plural echo signals in the form of separate radar images, wherein the image mixer determines the display colors for the individual radar image regions by using the levels of the echo signals read out from the first image memories. The radar system thus configured can read out the echo signals obtained at the same locations from the first image memories by using the first image memories as buffers even when the plural echo signals are obtained from different antennas and the antennas do not rotate in synchronism with each other.

In another feature of the invention, the radar system further includes an start point setter for generating imaging start addresses from where the plural echo signals are to be written in the first image memories, wherein, if the plural echo signals are obtained from a plurality of antennas, the start point setter determines the imaging start addresses from where the plural echo signals of the individual radar images are stored in the first image memories based on installation sites of the plurality of antennas. The radar system thus configured can prevent deviation of the radar images obtained from the individual antennas even when the antennas are installed at different positions.

In another feature of the invention, the radar system further includes a plurality of scan-to-scan correlators for separately performing a scan-to-scan correlation process on the plural echo signals, wherein the image mixer determines the display colors for the individual radar image regions by using data obtained by the scan-to-scan correlation process separately performed by the scan-to-scan correlators. The radar system thus configured can present a combination of radar pictures by using the processed data from which such unwanted signals as sea clutter have been removed by the scan-to-scan correlation process, so that the radar system can provide a user with a more appropriate radar picture.

In a case where the plural echo signals are obtained from different antennas, the radar system may further include a second image memory for storing the echo signal obtained from each successive antenna rotation in the form of a radar image, and an imaging controller for reading out the echo signals stored in the first image memories in synchronism with rotations of the individual antennas, wherein the echo signals stored in the first image memories are read out in synchronism with the rotations of the individual antennas and mixed together to thereby produce data to be written into the second image memory. The radar system thus configured can process the echo signals in synchronism with rotations of two or more antennas and present a combination of radar pictures which are updated in synchronism with the rotations of the individual antennas at appropriate antenna positions.

In still another feature of the invention, the aforementioned first image memories are used as processing image memories for performing the scan-to-scan correlation process. This makes it possible to write data in a desired coordinate system for on-screen presentation in the aforementioned second image memory and provide a radar picture in a user-specified presentation mode, such as relative motion head-up mode, relative motion course-up mode, relative motion north-up mode, true motion course-up mode or true motion north-up mode by directly presenting the data stored in the second image memory.

According to the radar system of the present invention, the image mixer determines the display colors for the individual radar image regions based on the combinations of the levels of the echo signals obtained from the same locations. Therefore, even when the radar pictures obtained from the plural echo signals are presented on a single display, the radar system can present a mixed radar picture in a manner that permits the radar operator to distinguish between the radar pictures observed with the individual echo signals together with intensities of the individual echo signals.

The radar system of the invention can properly combine the echo signals obtained under different conditions, such as different frequencies of radio waves transmitted from the antennas, transmission pulselengths, or output power levels, as well as different antenna structures or antenna positions (heights), making it possible to simultaneously recognize information on the echo signals obtained under different conditions on a single display screen. The radar system can therefore provide the radar operator with an optimum radar picture in a combined form suited to specific need of radar observation with a simple structure at low cost.

Furthermore, even when a plurality of antennas are installed at different positions onboard in order to interpolate echo signals in dead zones or to prevent misjudgment due to a false echo, for instance, the radar system of the invention can present a mixed radar picture in a manner that permits the radar operator to recognize the radar pictures obtained with the individual antennas as well as intensities of the individual echo signals. The radar system can therefore provide the radar operator with more exact information.

These and other objects, features and advantages of the invention will become more apparent upon a reading of the following detailed description in conjunction with the accompanying drawings.

### BRIEF DESCRIPTION OF THE DRAWINGS

FIG. 1 is a block diagram showing an example of a configuration of a radar system according to a first embodiment of the invention;

FIG. 2 is a diagram showing a matrix chart used for determining display colors and shades of echo signals;

FIG. 3 is a diagram for explaining an advantageous effect produced by the radar system of the first embodiment;

FIG. 4 is a block diagram showing an example of a configuration of a radar system according to a second embodiment of the invention;

FIG. 5 is a diagram for explaining a write operation for writing the echo signals into a display image memory of the radar system according to the second embodiment of the invention;

FIG. 6 is a block diagram showing a first variation of the radar system according to the second embodiment of the invention;

FIG. 7 is a block diagram showing a second variation of the radar system according to the second embodiment of the invention;

FIG. 8 is a block diagram showing an example of a configuration of a radar system according to a third embodiment of the invention; and

FIG. 9 is a diagram showing an example of signals having two different pulselengths A and B transmitted from an antenna of the radar system of the third embodiment.

### DETAILED DESCRIPTION OF THE PREFERRED EMBODIMENTS OF THE INVENTION

The invention is now described in detail, by way of example, with reference to the accompanying drawings.

### First Embodiment

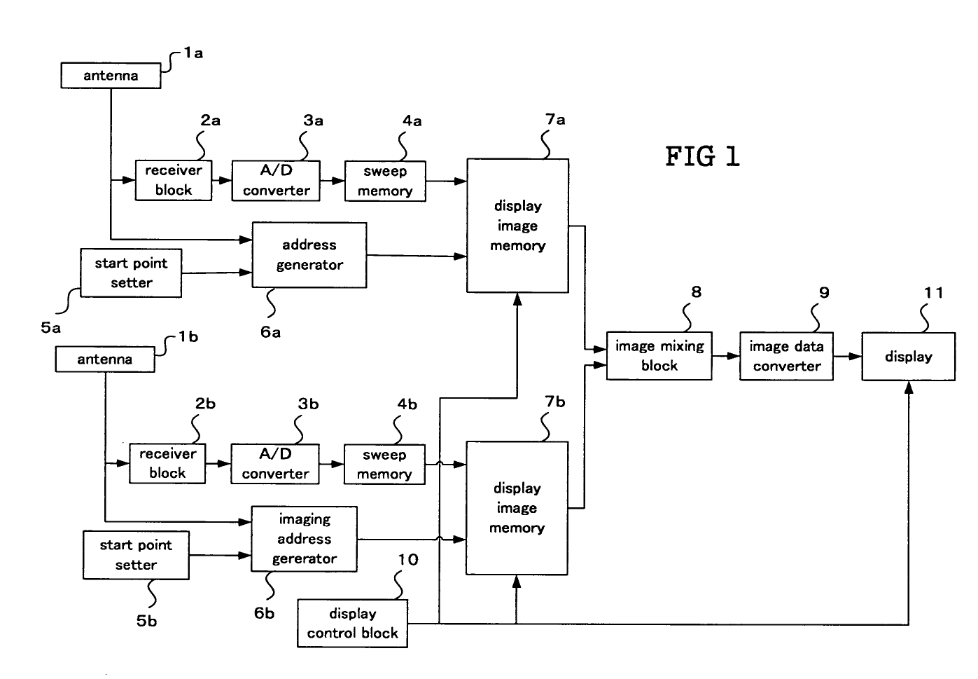

FIG. 1 is a block diagram showing the configuration of a radar system according to a first embodiment of the invention. The radar system of the first embodiment described below is an example of a radar system configured to generate one radar picture by mixing echo signals received by a pair of antennas 1a, 1b.

Referring to FIG. 1, the radar system of the first embodiment includes, in addition to the aforementioned antennas 1a, 1b, a pair of receiver blocks 2a, 2b, a pair of analog-to-digital (A/D) converters 3a, 3b, a pair of sweep memories 4a, 4b, a pair of start point setters 5a, 5b, a pair of address generators 6a, 6b, a pair of display image memories 7a, 7b (first image memories), an image mixing block 8, an image data converter 9, a display control block 10 and a display 11.

While rotating at a specified rate in a horizontal plane, each of the antennas 1a, 1b transmits a pulsed radio wave at specified repetition intervals and receives part of the radio wave, or echoes, reflected back from surrounding targets. The receiver blocks 2a, 2b down-convert the echoes of the transmitted radio wave to generate echo signals. The receiver blocks 2a, 2b then demodulate the echo signals and amplify the demodulated echo signals. The A/D converters 3a, 3b convert the analog echo signals obtained from the respective receiver blocks 2a, 2b into digital echo signals. The sweep memories 4a, 4b are buffers which each store a string of the A/D-converted echo signals for one radial sweep obtained from a single transmission in real time and write data on the echo signals for the one radial sweep into the respective display image memories 7a, 7b provided in a succeeding stage before the echo signals stored in the sweep memories 4a, 4b are overwritten by echo signals obtained from a succeeding transmission.

The start point setters 5a, 5b specify an imaging start address (Xs, Ys) from where the echo signals stored in the sweep memories 4a, 4b are to be written in the display image memories 7a, 7b, respectively. The start point setters 5a, 5b specify the imaging start address (Xs, Ys) for each of the display image memories 7a, 7b based on installation sites of the individual antennas 1a, 1b. This means that even when the two antennas 1a, 1b are installed at different positions on a mobile unit such as a ship, the start point setters 5a, 5b specify the imaging start address (Xs, Ys) for each of radar pictures obtained by the two antennas 1a, 1b, making it possible to adjust on-screen locations of sweep origins of the individual radar pictures to prevent mutual deviation thereof.

The address generators 6a, 6b generate write addresses indicating where the echo signals stored in the sweep memories 4a, 4b are to be written in the display image memories 7a, 7b, respectively. The write addresses generated by the address generators 6a, 6b are addresses (X, Y) of the display image memories 7a, 7b expressed by coordinates in a Cartesian coordinate system. These addresses (X, Y) (of which starting address corresponds to the sweep origin) designate locations in the display image memories 7a, 7b where successive pixel data for one sweep line are written therein, the addresses (X, Y) corresponding to readout locations r in the sweep memories 4a, 4b from where the pixel data are to be successively read out radially outward along the sweep line oriented in antenna direction θ. The antenna direction θ is expressed relative to the ship's heading, for example.

The aforementioned process of coordinate conversion is accomplished by hardware which performs mathematical operation expressed by the following equations:

x=Xs+r·sin θ

Y=Ys+r·cos θ

where
X, Y: address specifying each pixel of display image memories
Xs, Ys: address of imaging start point (sweep origin)
r: distance from sweep origin
θ: angular direction of sweep line

The display image memories 7a, 7b are memories each having a capacity to store the echo signal obtained from each successive antenna rotation in the form of a radar image. The echo signals stored in the sweep memories 4a, 4b are written in the aforementioned addresses (X, Y) of the respective display image memories 7a, 7b specified by the address generators 6a, 6b from one sweep line to the next in synchronism with the rotation of the antennas 1a, 1b, respectively. This means that even if the two antennas 1a, 1b do not rotate in synchronism with each other, it is possible to align on-screen locations of the echo signals obtained by the two antennas 1a, 1b by simultaneously reading out the echo signals from specific display areas of the two display image memories 7a, 7b.

The image mixing block 8 assigns a code number to image data representing the radar picture read out from each location in the display image memories 7a, 7b. More specifically, the image mixing block 8 gives a code number defining a specific display color to each piece of image data based on a combination of the levels of the echo signals simultaneously read out from the same location in the display image memories 7a, 7b. The image mixing block 8 classifies such combinations of the echo signal levels into a specified number of groups, selects display colors for the individual groups as well as shades of each display color according to the levels of the echo signals to be mixed, and outputs code numbers thus selected representing the selected display colors and shades to the image data converter 9 provided in a succeeding stage. There may exist a detection area in which the echo signal is obtained from only one of the antennas 1a, 1b. In this case, the echo signals should be combined assuming that one of the echo signals is at zero level.

The number of groups into which the image mixing block 8 classifies combinations of echo signal levels varies with the number of combinations of echo signals to be displayed in different colors. In a case where there are three input echo signals designated “a”, “b” and “c”, for example, image data derived from the echo signals can be classified into the following eight groups:
(1) Data considered to be obtained from the echo signal “a” alone;
(2) Data considered to be obtained from the echo signal “b” alone;
(3) Data considered to be obtained from the echo signal “c” alone;
(4) Data considered to be obtained from the echo signals “a” and “b”;
(5) Data considered to be obtained from the echo signals “b” and “c”;
(6) Data considered to be obtained from the echo signals “a” and “c”;
(7) Data considered to be obtained from all of the echo signals “a”, “b” and “c”; and
(8) Data on zero-signal regions in which all of the echo signals “a”, “b” and “c” are considered to be at zero level.

Provided that the number of input echo signals is m (which is an integer larger than 1), the total number of groups into which image data derived from the echo signals are classified is given by 2^{m}, in general terms.

In the radar system shown in FIG. 1, two echo signals are input into the image mixing block 8. Thus, when the aforementioned principle is applied to the example of FIG. 1, image data derived from the echo signals can be classified into the following four groups:
(1) Data considered to be obtained from the echo signal “a” alone;
(2) Data considered to be obtained from the echo signal “b” alone;
(3) Data considered to be obtained from both the echo signals “a” and “b”; and
(4) Data on zero-signal regions in which both the echo signals “a” and “b” are considered to be at zero level.

The image data converter 9 gives display colors corresponding to the code numbers output from the image mixing block 8 and generates display data used for presentation on the display 11. The display control block 10 gives readout addresses to the display image memories 7a, 7b to control readout timing of the echo signals stored in the display image memories 7a, 7b, the readout addresses specifying locations of pixel data to be read and displayed on the display 11. The display control block 10 also controls operation of the display 11. The display 11 is a display device, such as a cathode ray tube (CRT) or a liquid crystal display (LCD), for presenting the display data output from the image data converter 9.

Now, the working of the radar system of the present embodiment is described.

The echo signals obtained by the two antennas 1a, 1b are passed through the receiver blocks 2a, 2b, the A/D converters 3a, 3b and the sweep memories 4a, 4b and written into the display image memories 7a, 7b, respectively, forming therein full-circle radar images.

In this image-forming process, the echo signals are written at appropriate coordinates in the display image memories 7a, 7b corresponding to the installation sites of the individual antennas 1a, 1b to form the full-circle radar images. Therefore, even when the two antennas 1a, 1b are installed at different positions, it is possible to prevent deviation of the radar pictures obtained from the individual antennas 1a, 1b.

While the aforementioned image-forming process is in progress, the echo signals stored in the display image memories 7a, 7b are read out in synchronism with raster-scan operation of the display 11. The display 11 and the two display image memories 7a, 7b are controlled by the display control block 10.

As thus far discussed, the radar system of the embodiment has the display image memories 7a, 7b for individually storing the echo signals obtained by the two antennas 1a, 1b in the form of radar images, and the pixel data are simultaneously read out successively from the same locations (readout addresses) of the two display image memories 7a, 7b. With this arrangement, the pixel data are always read out simultaneously from the same locations of the display image memories 7a, 7b, so that the image mixing block 8 provided in a succeeding stage can mix the pixel data for proper on-screen presentation even if rotations of the two antennas 1a, 1b are not synchronized with each other.

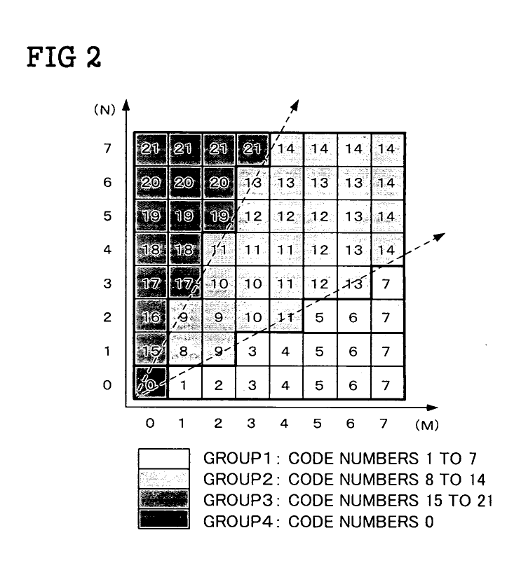

The echo signals output from the display image memories 7a, 7b to the image mixing block 8 are classified into several predetermined incremental ranges of echo signal levels based on the levels of the individual echo signals at the same locations. The image mixing block 8 assigns code numbers indicating display colors and shades to radar image regions at the individual locations and produces a matrix chart of the code numbers thus assigned as shown in FIG. 2, for example. In this embodiment, the image mixing block 8 produces a two-dimensional matrix chart of code numbers because the two echo signals are input into the image mixing block 8. If the number of input echo signals is three, the image mixing block 8 should produce a three-dimensional matrix chart of code numbers. Similarly, if the number of input echo signals is four, the image mixing block 8 should produce a four-dimensional matrix chart of code numbers.

Operation of the image mixing block 8 is now described, by way of example, in further detail.

First, the image mixing block 8 classifies the levels of each of the input echo signals. This classification of the echo signal levels is done by relative evaluation thereof. Specifically, the image mixing block 8 classifies the echo signal levels, from a minimum level to a maximum level, into N number (eight in this embodiment) of incremental ranges. Needless to say, the classification of the echo signal levels may be done by absolute evaluation. In a case where the classification is done by absolute evaluation, it is desirable to properly adjust such parameters as gain because the echo signal levels would vary with gain settings and other parameters. According to the invention, the levels of the input echo signals may be classified into any number of incremental ranges as long as the number of incremental ranges is equal to or less than the number of steps of digitization achieved by a preceding A/D conversion process. Also, the individual incremental ranges into which echo signal levels are classified need not necessarily have the same width. Furthermore, the individual echo signals may be classified into different numbers of incremental ranges.

Subsequently, the image mixing block 8 fits the results of the aforementioned classification of the echo signals obtained from the same locations (radar image regions) into a matrix chart like the one shown in FIG. 2 and assigns code numbers indicating display colors and shades to the individual radar image regions. As a consequence, the display colors and shades of the echo signals are determined for the individual radar image regions based on combinations of the levels of the input echo signals.

The matrix chart shown in FIG. 2 is described in detail. FIG. 2 shows an example of the matrix chart in which the combinations of the echo signal levels are classified into four groups, that is, group 1 to which code numbers 1 to 7 are assigned, group 2 to which code numbers 8 to 14 are assigned, group 3 to which code numbers 15 to 21 are assigned, and group 4 to which code number 0 is assigned. In the matrix chart of FIG. 2, numerals written in individual squares indicate the code numbers assigned by the image mixing block 8 to the individual radar image regions.

Here, the echo signal output from the display image memory 7a is referred to as the echo signal “a” and the echo signal output from the display image memory 7b is referred to as the echo signal “b” for the sake of explanation below. Referring to the matrix chart of FIG. 2, group 1 contains image data in radar image regions in which the level of the echo signal “a” is relatively high compared to that of the echo signal “b”, group 2 contains image data in radar image regions in which the levels of both the echo signal “a” and the echo signal “b” fall within a specific incremental range, group 3 contains image data in radar image regions in which the level of the echo signal “b” is relatively high compared to that of the echo signal “a”, and group 4 contains image data in a zero-signal region in which both the echo signals “a” and “b” are at zero level.

The aforementioned grouping of the image data in the individual radar image regions is performed based on the following mathematical expressions:

Group 1: M>α·N

Group 2: M≧N/α or N≧M/α

Group 3: N>α·M

Group 4: M=N=0

Where α>1, M is the numeral indicating to which one of the incremental ranges the level of the echo signal “a” belongs (M=0, 1, 2, 3, . . . ), and N is the numeral indicating to which one of the incremental ranges the level of the echo signal “b” belongs (N=0, 1, 2, 3, . . . ). It is possible to alter boundaries between the individual groups by varying the value of α.

In the example of FIG. 2, the echo signal levels (M, N) are classified into eight incremental ranges designated by the numerals 0 to 7, and the value of α is set to 2. Then, the image mixing block 8 classifies image data in the individual radar image regions into the following four groups: group 1 containing image data in the radar image regions in which the levels of the echo signals “a” and “b” satisfy the aforementioned condition “M>α·N”, group 2 containing image data in the radar image regions in which the levels of the echo signals “a” and “b” satisfy the aforementioned condition “M≧N/α or N≧M/α”, group 3 containing image data in the radar image regions in which the levels of the echo signals “a” and “b” satisfy the aforementioned condition “N>α·M”, and group 4 containing image data in the radar image regions in which the levels of the echo signals “a” and “b” satisfy the aforementioned condition “M=N=0”.

The image data in each of the groups thus classified is further classified according to the combinations of the echo signal levels and, as a result, the image mixing block 8 assigns code numbers 1 to 7 to the image data in group 1, code numbers 8 to 14 to the image data in group 2, and code numbers 15 to 21 to the image data in group 3.

The image data converter 9 gives display colors corresponding to the code numbers output from the image mixing block 8 and generates display data used for presentation on the display 11. The display colors given by the image data converter 9 are predetermined. In this embodiment, the image data in group 1 are painted in different shades of yellow, the image data in group 2 are painted in different shades of orange, and the image data in group 3 are painted in different shades of green, wherein shades of a base color assigned to each group are varied in proportion to the value of a higher one of the echo signal levels combined in each radar image region so that darker shades of the base color are used for higher echo signal levels and lighter shades of the base color are used for lower echo signal levels, for instance. This approach makes it possible to represent changes in the echo signal levels in an easy-to-understand fashion on-screen. The levels of both the echo signals “a” and “b” are zero in zero-signal regions so that these regions may be painted in black or white, for instance. The image data converter 9 then delivers the display data to the display 11 for on-screen presentation of a radar picture.

Given below for reference is an example of red, green and blue (RGB) values of the display data produced by the image data converter 9, in which shown to the left of colons “:” are the code numbers written in the matrix chart and values shown in parentheses ( ), from left to right, to the right of each colon are R, G and B values.

| | |
|---|---|
| 0: (0, 0, 0) | 1: (255, 255, 128) |
| 2: (255, 255, 107) | 3: (255, 255, 86) |
| 4: (255, 255, 65) | 5: (255, 255, 44) |
| 6: (255, 255, 22) | 7: (255, 255, 0) |
| 8: (255, 190, 120) | 9: (255, 175, 100) |
| 10: (255, 160, 80) | 11: (255, 145, 60) |
| 12: (255, 130, 40) | 13: (255, 115, 20) |
| 14: (255, 100, 0) | 15: (128, 255, 128) |
| 16: (107, 234, 107) | 17: (86, 213, 86) |
| 18: (65, 192, 65) | 19: (44, 161, 44) |
| 20: (22, 150, 22) | 21: (0, 128, 0) |

With this arrangement, it is possible to classify the image data into the aforementioned four groups, that is, group 1 containing radar image regions in which the level of the echo signal “a” is relatively high compared to that of the echo signal “b”, group 2 containing radar image regions in which the levels of both the echo signal “a” and the echo signal “b” fall within the specific incremental range, group 3 containing radar image regions in which the level of the echo signal “b” is relatively high compared to that of the echo signal “a”, and group 4 containing zero-signal regions in which both the echo signals “a” and “b” are at zero level, with varying shades of display colors assigned to the individual radar image regions for intuitive visualization of different echo signal levels.

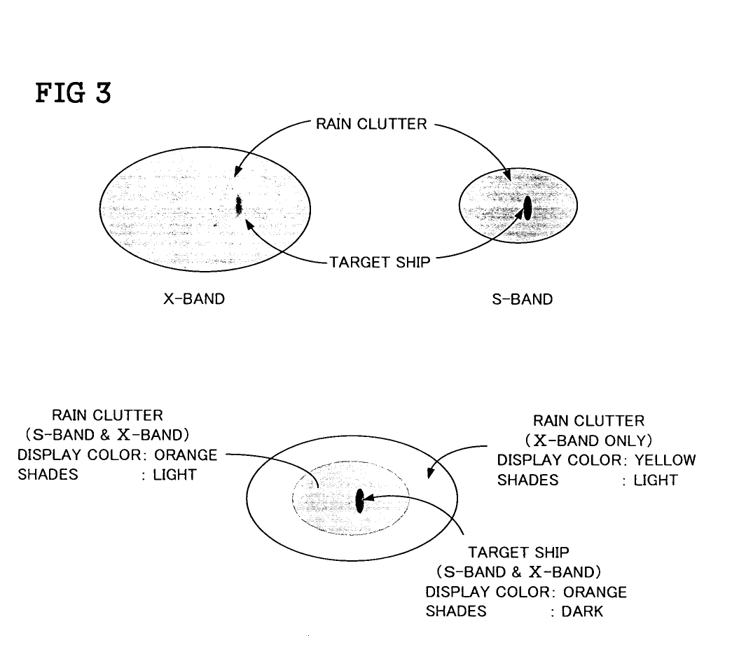

FIG. 3 is a diagram for explaining an advantageous effect produced by the radar system of the first embodiment of the present invention. Shown in this Figure is an example of a radar picture displayed on-screen by combining echo signals obtained by an X-band radar apparatus and an S-band radar apparatus.

As shown in an upper-left part of FIG. 3, rain/snow clutter spreads over wide area and discrimination between target echo and rain clutter is difficult. The X-band is susceptible to the influence of rain/snow so that an echo from a target ship attenuates under rainy conditions and the target echo is obscured by rain clutter as illustrated. On the other hand, as shown in an upper-right part of FIG. 3, rain/snow clutter appears in limited area and attenuation of target echo is small so that discrimination between target echo and rain clutter is easy. The S-band is less susceptible to the influence of rain/snow so that the rain clutter appears in a reduced area and the target echo can be distinguished more distinctly from the rain clutter.

If the echo signals obtained by the X- and S-band radar apparatuses are mixed by using the above-described arrangement of the present invention, a radar picture shown in a lower part of FIG. 3 is obtained. In the radar picture thus produced, a portion of the rain clutter picked up by the X-band radar apparatus alone has a low echo signal level and thus is painted in one or more lighter shades of yellow, whereas a portion of the rain clutter picked up by both the X- and S-band radar apparatuses contains a combination of low-level echo signals and thus is painted in one or more lighter shades of orange. On the other hand, the echo from the target ship picked up by both the X- and S-band radar apparatuses is painted in one or more darker shades of orange selected in accordance with levels of the S-band echo signal which are higher than levels of the X-band echo signal. This approach of the invention makes it possible to present the echo signals obtained by the X- and S-band radar apparatuses in a manner that permits a radar operator to distinguish between the X- and S-band echo signals, yet enabling discrimination of different echo signal levels from the shades of each display color.

While the example of FIG. 3 does not contain an echo having a high echo signal level picked up by the S-band radar apparatus alone, an echo of a bird, for example, which produces high echo signal levels when picked up by the S-band radar apparatus only is painted in green with one or more shades according to the received echo signal levels.

Generally, a radar apparatus is provided with such controls as a gain control for adjusting gain so that the radar operator can vary the intensity of the received echo signal depending on conditions of radar observation, for instance. The radar system of the present invention can present blips of echoes detected by the X- or S-band radar apparatus alone and blips of echoes detected by both the X- and S-band radar apparatuses in different display colors in a readily distinguishable manner. This approach provides an advantage that the radar operator can properly adjust the gain of the X- and S-band radar apparatuses while observing the echo signals obtained by the X- and S-band radar apparatuses. To be more specific, the radar operator can obtain a radar picture with properly mixed echo signals by separately adjusting the gain of the X- and S-band radar apparatuses in such a manner that targets which can be reliably detected by the plural antennas 1a, 1b would produce echoes having approximately the same echo signal level.

In a conventional dual radar system including X- and S-band radar apparatuses, it has not been possible to adjust gain and other control parameters of the X- and S-band radar apparatuses while observing X- and S-band echo signals on a single screen and, therefore, it has been difficult to compare X- and S-band echoes under the same conditions. In contrast to the prior art system, the above-described dual radar system of the present invention permits the radar operator to separately adjust the gain of the X- and S-band radar apparatuses in a proper fashion while observing the X- and S-band echo signals on a single screen, so that the radar operator can easily compare the X- and S-band echoes under the same conditions. While the invention has been described above, by way of example, with reference to the dual radar system in which the X- and S-band radar apparatuses are combined, the invention is similarly applicable to a radar system configured to handle a combination of signals obtained by receiving different kinds of radio waves.

As thus far described, the radar system of the first embodiment of the present invention can arbitrarily vary display colors of the radar pictures which are together displayed on-screen in a mixed form according to combinations of the levels of a plurality of input echo signals. Therefore, the radar system of the first embodiment makes it possible to display radar echoes obtained by the individual radar apparatuses in a readily distinguishable manner, yet providing simultaneous presentation of intensities of the received echo signals.

The radar system thus configured can properly combine the echo signals obtained under different conditions, such as different frequencies of radio waves transmitted from the antennas, transmission pulselengths, or output power levels, as well as different antenna structures or antenna positions (heights), present the echo signals in a combined form suited to specific need of radar observation, and thereby provide an optimum radar picture at all times without requiring the radar operator to switch between different display screens.

In one variation of the first embodiment of the invention, the above-described radar system may be modified to include a scan-to-scan correlator for performing a process of scan-to-scan correlation, whereby the image mixing block 8 determines display colors of the radar picture using data obtained upon execution of the scan-to-scan correlation process.

### Second Embodiment

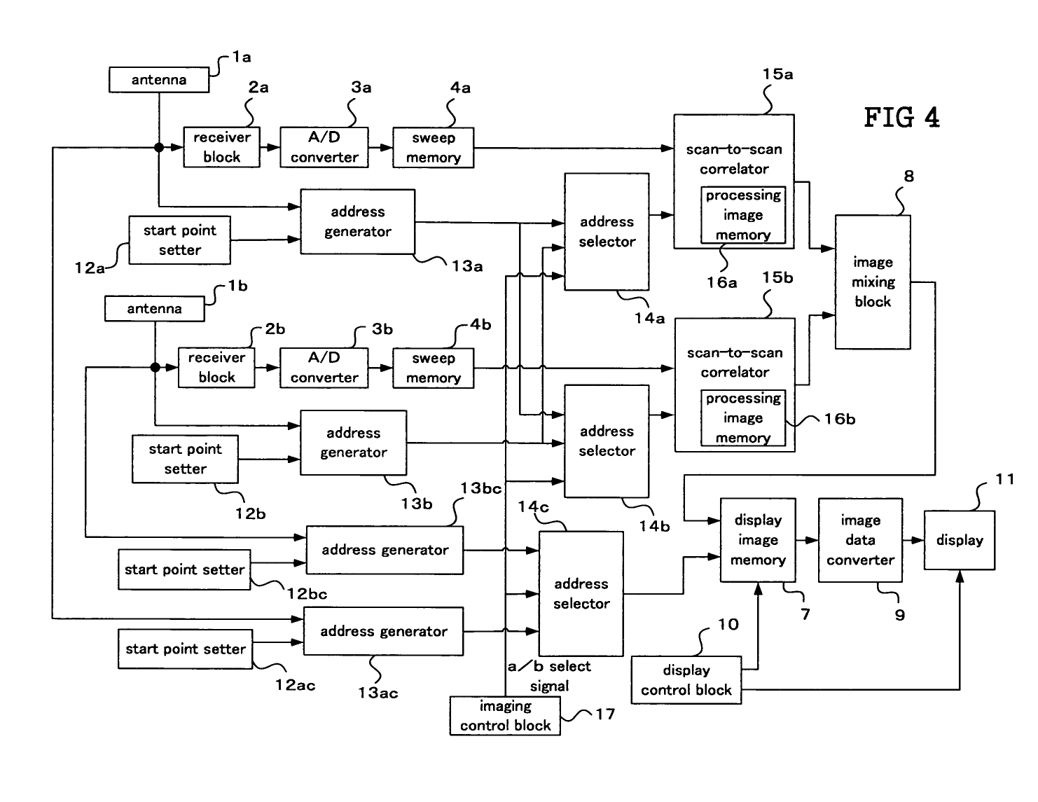

FIG. 4 is a block diagram showing the configuration of a radar system according to a second embodiment of the invention. The radar system of the second embodiment described below is another example of a radar system configured to generate one radar picture by mixing echo signals received by a pair of antennas 1a, 1b.

Referring to FIG. 4, the radar system of the second embodiment includes, in addition to the aforementioned antennas 1a, 1b, a pair of receiver blocks 2a, 2b, a pair of A/D converters 3a, 3b, a pair of sweep memories 4a, 4b, a display image memory 7 (second image memory), an image mixing block 8, an image data converter 9, a display control block 10, a display 11, four start point setters 12a, 12b, 12ac, 12bc, four address generators 13a, 13b, 13ac, 13bc, a pair of address selectors 14a, 14b, a display image memory imaging address selector 14c, a pair of scan-to-scan correlators 15a, 15b and an imaging control block 17. The scan-to-scan correlators 15a, 15b include processing image memories 16a, 16b (first image memories), respectively.

Except when the two antennas 1a, 1b rotate in synchronism with each other, it is necessary to simultaneously process the echo signals obtained from the same location with the two antennas 1a, 1b by one method or another in order to present the echo signals obtained from the same location in a mixed form.

The foregoing discussion of the first embodiment has shown the configuration in which the two display image memories 7a, 7b separately store the echo signals obtained with the individual antennas 1a, 1b as independent images and the display control block 10 performs read operation for simultaneously reading out the echo signals obtained from the same location at a point in time when the display control block 10 reads out the echo signals from specific display areas of the two display image memories 7a, 7b.

What is characteristic of the second embodiment of the invention is that the radar system of this embodiment is provided with the scan-to-scan correlators 15a, 15b and the echo signals obtained from the same location are simultaneously read out from the processing image memories 16a, 16b of the scan-to-scan correlators 15a, 15b and already mixed data is written into the display image memory 7. The radar system of the second embodiment thus configured can present the radar pictures obtained with the two antennas 1a, 1b in synchronism with rotations thereof in a desired presentation mode.

Now, the radar system of the second embodiment is described in detail, wherein elements like those of the first embodiment previously described with reference to FIG. 1 are designated by the same symbols and a description of such elements is omitted.

The start point setters 12a, 12b specify imaging start addresses (Xa, Ya) and (Xb, Yb) from where the echo signals stored in the sweep memories 4a, 4b are to be written in the processing image memories 16a, 16b after execution of a scan-to-scan correlation process by the scan-to-scan correlators 15a, 15b, respectively.

While the scan-to-scan correlation process is in progress, the start point setters 12ac, 12bc specify imaging start addresses (Xac, Yac) and (Xbc, Ybc) from where data processed by the scan-to-scan correlators 15a, 15b is to be written in the display image memory 7. The start point setters 12ac, 12bc specify the imaging start addresses (Xac, Yac) and (Xbc, Ybc) of the display image memory 7 based on installation sites of the individual antennas 1a, 1b. This means that even when the two antennas 1a, 1b are installed at different positions, the start point setters 12ac, 12bc specify the imaging start addresses (Xac, Yac) and (Xbc, Ybc) in a manner that makes it possible to prevent mutual deviation of the individual radar pictures.

The address generators 13a, 13b generate write addresses indicating locations of the processing image memories 16a, 16b where the echo signals stored in the sweep memories 4a, 4b are to be written, respectively, for performing the aforementioned scan-to-scan correlation process. The write addresses generated by the address generators 13a, 13b designate coordinates the locations of the processing image memories 16a, 16b where the echo signals should be written for true motion presentation. True motion is a presentation mode in which stationary targets (e.g., land masses) remain stationary on-screen while the sweep origin (own ship) moves according to own ship's moving direction and speed. As stationary target echoes remain stored in the same locations of the processing image memories 16a, 16b, it is possible to properly suppress or remove such unwanted signals as sea clutter as a result of the scan-to-scan correlation process performed by the scan-to-scan correlators 15a, 15b over several past scans (antenna rotations).

The address generators 13ac, 13bc generate write addresses indicating locations of the display image memory 7 where data output from the image mixing block 8 after execution of the scan-to-scan correlation process are to be written.

The address selectors 14a, 14b are selectors for controlling write and read operations for writing and reading results of the scan-to-scan correlation process in and from the processing image memories 16a, 16b, respectively. In this embodiment, the address selectors 14a, 14b switches processing cycles of the data derived from the antenna 1a and the antenna 1b according to a time division scheme based on an a/b select signal output from the imaging control block 17.

The display image memory imaging address selector 14c is a selector for controlling switching of the write addresses of the display image memory 7 where the data after execution of the scan-to-scan correlation process are to be written. In this embodiment, the display image memory imaging address selector 14c switches locations of the display image memory 7 where the data are to be written based on the a/b select signal output from the imaging control block 17.

The scan-to-scan correlators 15a, 15b together constitute a processing block for performing the scan-to-scan correlation process on the echo signals obtained from the antennas 1a, 1b, respectively. The processing image memories 16a, 16b are memories used for performing the scan-to-scan correlation process. The scan-to-scan correlation process is an image processing technique for suppressing or removing such unwanted signals as sea clutter by correlating images obtained over several past scans (antenna rotations).

The imaging control block 17 delivers the a/b select signal to the address selectors 14a, 14b and the display image memory imaging address selector 14c. The a/b select signal is a control signal for controlling the radar system of the embodiment to alternately process the echo signals obtained from the two antennas 1a, 1b with specified image processing timing. Specifically, the a/b select signal alternates between “0” and “1” values, “0” indicating the timing for selecting the echo signal obtained from the antenna 1a and “1” indicating the timing for selecting the echo signal obtained from the antenna 1b. Typically, the a/b select signal is switched between the “0” and “1” values each time image data is written in one pixel.

Now, the working of the radar system of the present embodiment is described.

### (1) When the a/b Select Signal is “0”:

When the value of the a/b select signal is “0”, the radar system processes the image data in synchronism with processing timing for processing the echo signal obtained from the antenna 1a.

When the address selector 14a receives the 0-valued a/b select signal from the imaging control block 17, the address selector 14a selects an output address of the address generator 13a and delivers a write address fed from the address generator 13a to the processing image memory 16a of the scan-to-scan correlator 15a.

As a consequence, the scan-to-scan correlator 15a performs the scan-to-scan correlation process on pixel data output from the sweep memory 4a and a scan-to-scan correlation result is written into the processing image memory 16a. At the same time, the scan-to-scan correlator 15a outputs the scan-to-scan correlation result as one input signal of the image mixing block 8.

On the other hand, when the address selector 14b receives the 0-valued a/b select signal, the address selector 14b selects the output address of the address generator 13a and delivers a readout address fed from the address generator 13a to the processing image memory 16b of the scan-to-scan correlator 15b.

As a consequence, pixel data stored in the processing image memory 16b is read out from the same locations as the scan-to-scan correlation result output from the scan-to-scan correlator 15a and the scan-to-scan correlator 15b outputs this pixel data as another input signal of the image mixing block 8. The pixel data read out from the processing image memory 16b at this time is the latest data which has been obtained from the antenna 1b and already gone through the scan-to-scan correlation process.

Also, when the display image memory imaging address selector 14c receives the 0-valued a/b select signal, the display image memory imaging address selector 14c selects an output address of the address generator 13ac and delivers a write address of the display image memory 7.

As a consequence, an output signal of the image mixing block 8 is written into the display image memory 7 in synchronism with the processing timing for the echo signal obtained from the antenna 1a. At this time, the pixel data need not necessarily be written into the display image memory 7 at coordinates formatted for true motion mode but may be written at coordinates formatted for a user-specified presentation mode, such as relative motion head-up mode, relative motion course-up mode, relative motion north-up mode, true motion course-up mode or true motion north-up mode. The radar system of the present embodiment can store the pixel data in the display image memory 7 in a manner suited to the user-specified presentation mode, making it possible to easily present the radar picture in the desired presentation mode by using an ordinary data readout process.

### (2) When the a/b Select Signal is “1”:

When the value of the a/b select signal is “1”, the radar system processes the image data in synchronism with processing timing for processing the echo signal obtained from the antenna 1b.

When the address selector 14b receives the 1-valued a/b select signal from the imaging control block 17, the address selector 14b selects an output address of the address generator 13b and delivers a write address fed from the address generator 13b to the processing image memory 16b of the scan-to-scan correlator 15b.

As a consequence, the scan-to-scan correlator 15b performs the scan-to-scan correlation process on pixel data output from the sweep memory 4b and a scan-to-scan correlation result is written into the processing image memory 16b. At the same time, the scan-to-scan correlator 15b outputs the scan-to-scan correlation result as one input signal of the image mixing block 8.

On the other hand, when the address selector 14a receives the 1-valued a/b select signal, the address selector 14a selects the output address of the address generator 13b and delivers a readout address fed from the address generator 13b to the processing image memory 16a of the scan-to-scan correlator 15a.

As a consequence, pixel data stored in the processing image memory 16a is read out from the same locations as the scan-to-scan correlation result output from the scan-to-scan correlator 15b and the scan-to-scan correlator 15a outputs this pixel data as another input signal of the image mixing block 8. The pixel data read out from the processing image memory 16a at this time is the latest data which has been obtained from the antenna 1a and already gone through the scan-to-scan correlation process as previously mentioned with reference to the pixel data read out from the processing image memory 16b.

Also, when the display image memory imaging address selector 14c receives the 1-valued a/b select signal, the display image memory imaging address selector 14c selects an output address of the address generator 13bc and delivers a write address of the display image memory 7.

As a consequence, an output signal of the image mixing block 8 is written into the display image memory 7 in synchronism with the processing timing for the echo signal obtained from the antenna 1b. At this time, the pixel data need not necessarily be written into the display image memory 7 at coordinates formatted for true motion mode but may be written at coordinates formatted for any user-specified presentation mode, such as relative motion head-up mode, relative motion course-up mode, relative motion north-up mode, true motion course-up mode or true motion north-up mode. The radar system of the present embodiment can store the pixel data in the display image memory 7 in a manner suited to the user-specified presentation mode, making it possible to easily present the radar picture in the desired presentation mode by using the ordinary data readout process.

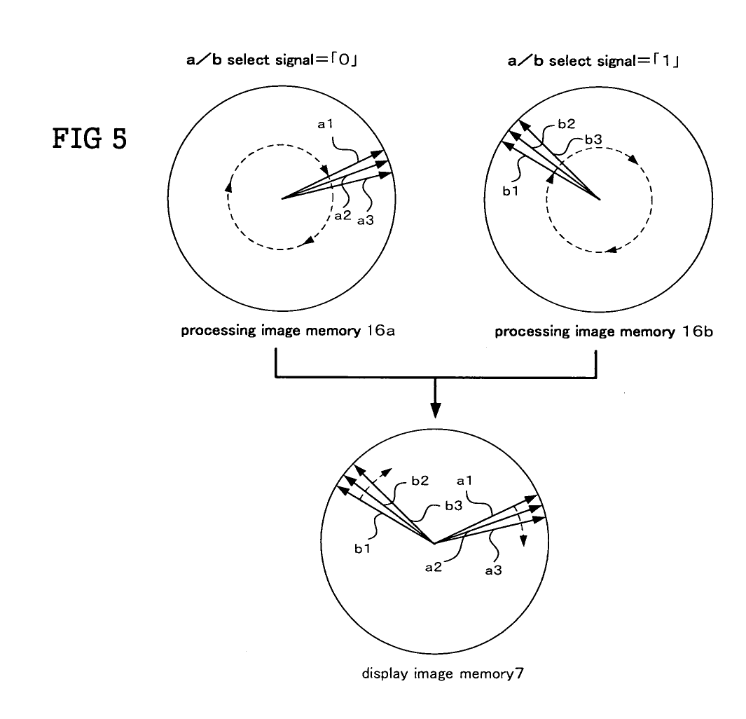

FIG. 5 is a diagram for explaining a write operation for writing the echo signals into the display image memory 7 according to the second embodiment of the invention.

When the value of the a/b select signal is “0”, the radar system processes the image data in synchronism with the processing timing for processing the echo signal obtained from the antenna 1a as stated earlier. Specifically, the scan-to-scan correlator 15a performs the scan-to-scan correlation process on the echo signal on sweep lines a1, a2, a3, and so on in this order as shown in FIG. 5 and the scan-to-scan correlation result is written into the image mixing block 8 in synchronism with rotation of the antenna 1a. At the same time, data written in specified locations of the processing image memory 16a and data stored in corresponding locations of the processing image memory 16b are input into the image mixing block 8. These two inputs are mixed by the image mixing block 8 and results of this mixing operation are written into the display image memory 7 at angular positions of the sweep lines a1, a2, a3, and so on.

When the value of the a/b select signal is “1”, on the other hand, the radar system processes the image data in synchronism with the processing timing for processing the echo signal obtained from the antenna 1b as stated earlier. Specifically, the scan-to-scan correlator 15b performs the scan-to-scan correlation process on the echo signal on sweep lines b1, b2, b3, and so on in this order as shown in FIG. 5 and the scan-to-scan correlation result is written into the image mixing block 8 in synchronism with rotation of the antenna 1b. At the same time, data written in specified locations of the processing image memory 16b and data stored in corresponding locations of the processing image memory 16a are input into the image mixing block 8. These two inputs are mixed by the image mixing block 8 and results of this mixing operation are written into the display image memory 7 at angular positions of the sweep lines b1, b2, b3, and so on.

The radar system working in the above-described fashion can update the radar picture in synchronism with the rotations of the individual antennas 1a, 1b even when the plural echo signals are together displayed on-screen, yet permitting the radar operator to recognize detection areas of the individual antennas 1a, 1b.

As thus far discussed, the radar system of the second embodiment is configured to alternately perform the scan-to-scan correlation process on the echo signals obtained from the antenna 1a and the antenna 1b in synchronism with the respective processing timings by using the a/b select signal, so that the radar system can update the radar picture in synchronism with the rotations of the individual antennas 1a, 1b.

According to the foregoing discussion, the radar system of the second embodiment is configured such that the echo signals are controllably written into and read out from the processing image memories 16a, 16b and the display image memory 7 by using the a/b select signal. This configuration of the radar system of the embodiment may be modified in such a way that the imaging control block 17 watches write and read requests for the individual memories and coordinates execution of write and read operations for writing and reading out the echo signals into and from the processing image memories 16a, 16b and the display image memory 7.

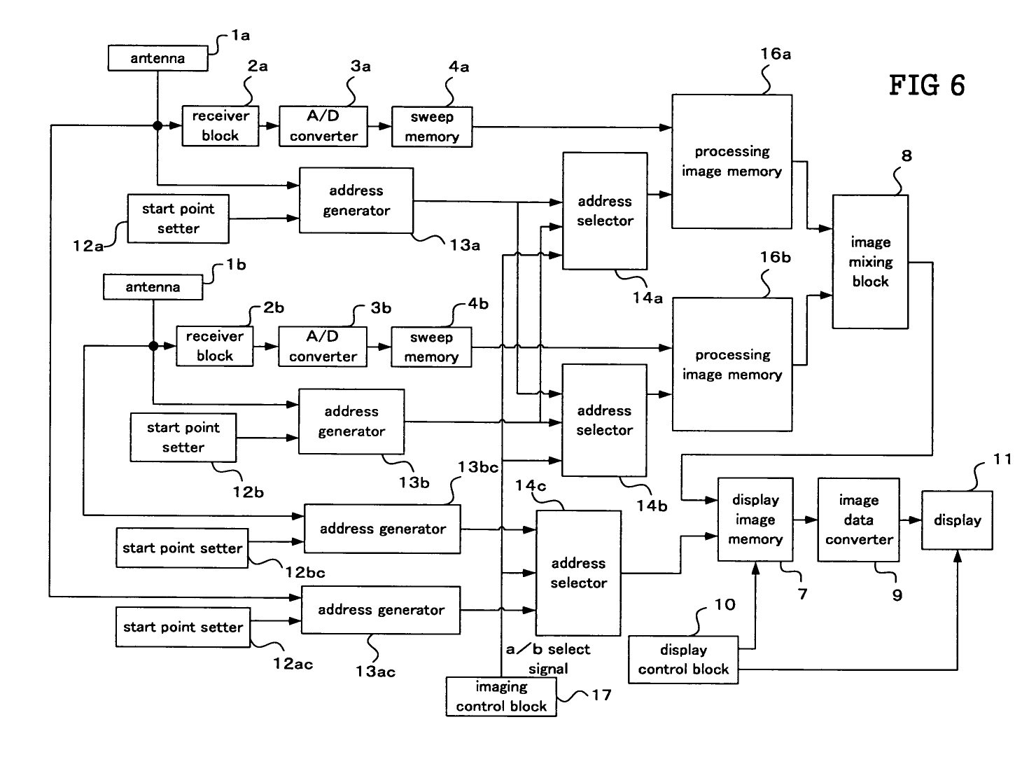

As thus far discussed, the radar system of the second embodiment is configured to process the image data in synchronism with the rotations of the individual antennas 1a, 1b by using the processing image memories 16a, 16b for performing the scan-to-scan correlation process. If the radar system is provided with processing image memories 16a, 16b for separately storing the echo signals obtained from the individual antennas 1a, 1b at appropriate coordinates as shown in FIG. 6, it is possible to update the radar picture in synchronism with the rotations of the individual antennas 1a, 1b.

Also, while the radar system of the second embodiment has thus far been described as being configured to process the image data in synchronism with the rotations of both of the two antennas 1a, 1b, the radar system may be as modified as to process the image data in synchronism with the rotation of one of the two antennas 1a, 1b. This modification of the embodiment allows for a more simplified or smaller-sized circuit configuration.

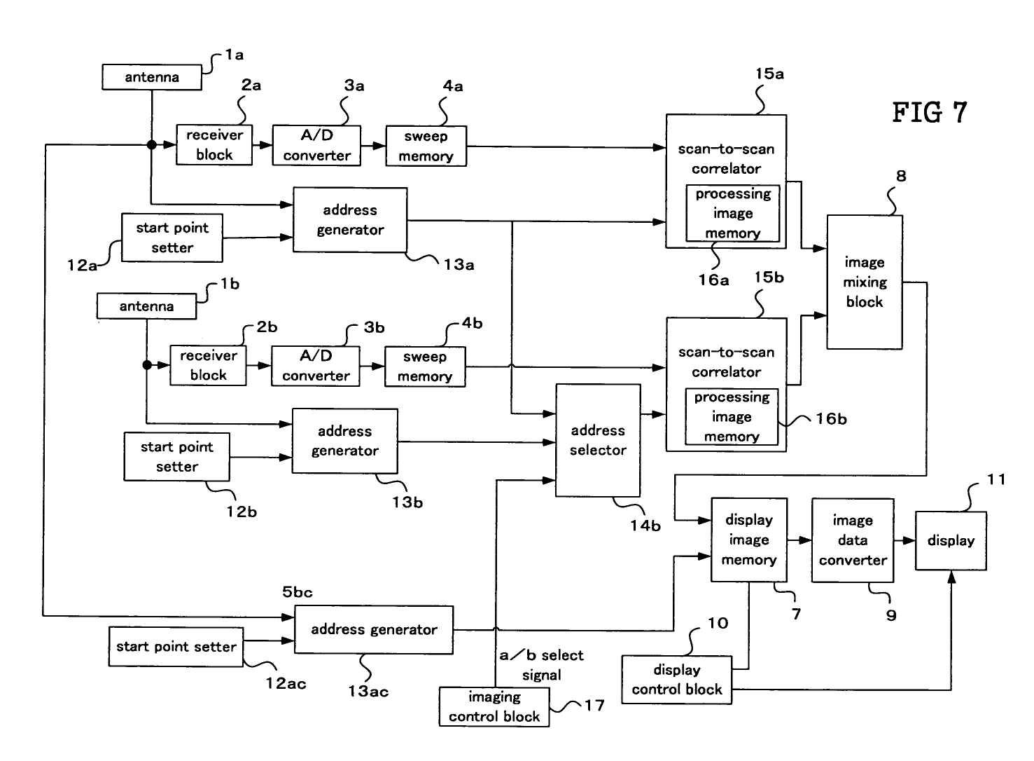

If the radar system is configured such that the results of the mixing operation output from the image mixing block 8 are written into the display image memory 7 in synchronism with the rotation of the antenna 1a only, for example, it is possible to eliminate the start point setter 12bc, the address generator 13bc, the display image memory imaging address selector 14c and the address selector 14a as shown in FIG. 7. To be more specific, the start point setter 12bc and the address generator 13bc are not required because it is not necessary to generate addresses in synchronism with the rotation of the antenna 1b. Also, the display image memory imaging address selector 14c is not required because write addresses of the display image memory 7 are only those output from the address generator 13ac. In addition, it becomes unnecessary to read out pixel data stored in the processing image memory 16a on the side of the antenna 1a from the same pixel locations of the echo signal obtained from the antenna 1b when the echo signal obtained from the antenna 1b is being written. For this reason, write addresses of the scan-to-scan correlator 15a can be directly output from the address generator 13a and, therefore, the address selector 14a becomes unnecessary.

The plural echo signals mixed in the radar system of either of the foregoing first and second embodiments may be the echo signals generated in the same radar system or input from one or external radar apparatuses through a local area network (LAN), for example.

### Third Embodiment

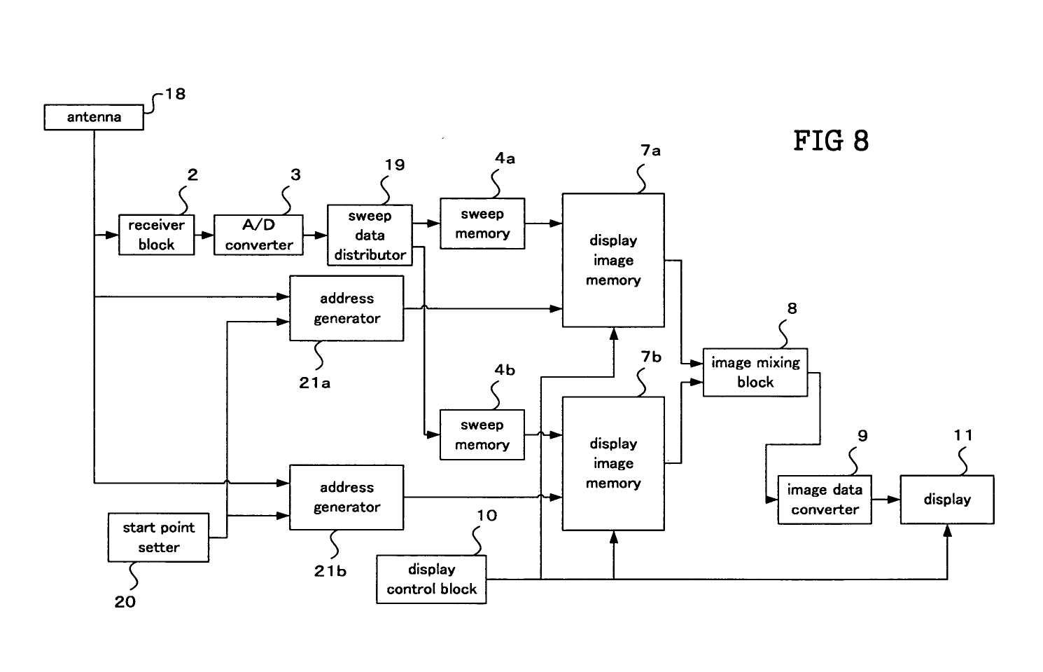

FIG. 8 is a block diagram showing the configuration of a radar system according to a third embodiment of the invention. The radar system of this embodiment transmits signals having different pulselengths through a single antenna 18 according to a specified transmit pulse pattern and mixes echo signals obtained with the different pulselengths to produce a single radar picture for on-screen presentation.

Referring to FIG. 8, the radar system of the third embodiment includes, in addition to the aforementioned antenna 18, a receiver block 2, an A/D converter 3, a pair of sweep memories 4a, 4b, a pair of display image memories 7a, 7b (first image memories), an image mixing block 8, an image data converter 9, a display control block 10, a display 11, a sweep data distributor 19, an start point setter 20 and a pair of address generators 21a, 21b. In the following discussion, elements like those of the first embodiment previously described with reference to FIG. 1 are designated by the same symbols and a description of such elements is omitted.

The antenna 18 transmits pulse signals having two or more different pulselengths according to the aforementioned specified transmit pulse pattern which defines the order of transmission of pulses having the different pulselengths and pulse repetition intervals. Described below is an example in which the antenna 18 alternately transmits the pulse signals having two different pulselengths A and B (A>B) at predefined pulse repetition intervals.

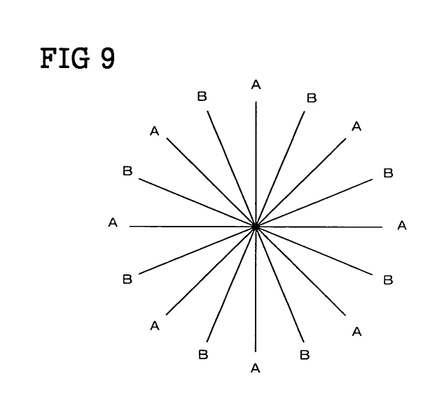

FIG. 9 is a diagram showing an example of the pulse signals having the two different pulselengths A and B transmitted from the antenna 18 of the radar system of the third embodiment.

Referring to FIG. 9, the radar system of the embodiment alternately transmits the pulse signals having the two different pulselengths A and B during each rotation of the antenna 18 and obtains the echo signals corresponding to the pulse signals transmitted at the two different pulselengths A and B. With this arrangement, the radar system can obtain two kinds of radar pictures under different detecting conditions (pulselengths) during each rotation of the antenna 18. Strictly speaking, the pulse signals transmitted at the two different pulselengths A and B in two successive transmit cycles cover different sector areas because the pulselengths are switched while the antenna 18 is rotating. However, the pulse signals are transmitted at an extremely high pulse repetition frequency and each beam of radio wave transmitted and received by the antenna 18 has a specific horizontal beam angle, so that at least two beams of radio wave transmitted in two adjacent angular directions may be regarded as covering the same sector area. It is also possible to obtain echo data from the same sector area by performing interpolating operation on the echo signals received from the two adjacent angular directions.

The sweep data distributor 19 separates the echo signals A/D-converted by the A/D converter 3 and selectively delivers the A/D-converted echo signals to the sweep memories 4a and 4b for real-time storage therein. Subsequently, the echo signals obtained with the same pulselengths are read out from the sweep memories 4a and 4b and output to the display image memories 7a and 7b, respectively. As a result, the echo signal obtained with the pulse signal transmitted at the pulselength A is output to the display image memory 7a while the echo signal obtained with the pulse signal transmitted at the pulselength B is output to the display image memory 7b, respectively.

The start point setter 20 specifies an imaging start address from where the echo signals obtained with the two different pulselengths A and B are to be written in the display image memories 7a, 7b, respectively. Since the radar system of the present embodiment handles the echo signals obtained with the single antenna 18, the start point setter 20 specifies the same imaging start address for the two display image memories 7a, 7b.

The address generators 21a, 21b generate write addresses indicating where the echo signals stored in the sweep memories 4a, 4b for the two different pulselengths A and B are to be written into the display image memories 7a, 7b according to the transmit pulse pattern of the pulse signals transmitted at the two pulselengths A and B, respectively.

In the radar system of the third embodiment thus configured, it is possible to store the echo signals alternately obtained with the different pulselengths through the antenna 18 according to a time division scheme at appropriate coordinates of separate imaging coordinate systems (display image memories 7a, 7b). The echo signals separately stored in the two display image memories 7a, 7b are mixed by the image mixing block 8 in the same way as in the radar system of the first embodiment, whereby the radar system of the third embodiment can produce the same advantageous effect as the radar system of the first embodiment.

It should be appreciated from the foregoing discussion that the radar system of the third embodiment of the present invention is advantageous even when the pulse signals are transmitted at different pulselengths through the single antenna 18. Specifically, the radar system of the third embodiment can arbitrarily vary display colors of the radar pictures which are together displayed on-screen in a mixed form according to combinations of the levels of a plurality of input echo signals. Therefore, the radar system of the third embodiment makes it possible to display radar echoes obtained with the individual pulselengths in a readily distinguishable manner, yet providing simultaneous presentation of intensities of the received echo signals.

In one variation of the third embodiment of the invention, the above-described radar system may be modified to include a scan-to-scan correlator for performing a process of scan-to-scan correlation, whereby the image mixing block 8 determines display colors of the radar picture using data obtained upon execution of the scan-to-scan correlation process.

What is claimed is:

1. A radar system configured to present plural echo signals in a mixed form, said radar system comprising an image mixer for receiving the plural echo signals and determining display colors based on combinations of the levels of the echo signals obtained from the same locations.

2. The radar system according to claims 1, wherein said image mixer classifies the combinations of the levels of the echo signals into a predetermined number of groups and selects display colors for the individual groups.

3. The radar system according to claims 1, wherein said image mixer classifies the combinations of the levels of the echo signals into a predetermined number of groups according to the number of the echo signals to be mixed and selects display colors for the individual groups as well as shades of each display color according to the levels of the echo signals to be mixed.

4. The radar system according to claim 1 further comprising first image memories for storing the plural echo signals in the form of separate radar images, wherein said image mixer determines the display colors by using the levels of the echo signals read out from said first image memories.

5. The radar system according to claim 4 further comprising an start point setter for generating imaging start addresses from where the plural echo signals are to be written in said first image memories, wherein, if the plural echo signals are obtained from a plurality of antennas, said start point setter determines the imaging start addresses based on installation sites of the plurality of antennas.

6. The radar system according to claim 1 further comprising a plurality of scan-to-scan correlators for separately performing a scan-to-scan correlation process on the plural echo signals, wherein said image mixer determines the display colors by using results of the scan-to-scan correlation process.

7. A radar system comprising:
a plurality of echo signal generating units, each including:
an antenna for transmitting and receiving a radio wave;
a receiver block for generating an echo signal from the reflected radio wave received by said antenna;
an A/D converter for converting the echo signal from an analog form into a digital form;
a sweep memory for storing the A/D-converted echo signal output from said A/D converter in real time;
a first image memory for storing the echo signal obtained from each successive antenna rotation in the form of a radar image;
an start point setter for generating an imaging start address from where the echo signal stored in said sweep memory is to be written in said first image memory; and
an address generator for generating write addresses indicating where the echo signal stored in said sweep memory is to be written in said first image memory;
a display controller for controlling readout timing of the echo signal stored in said first image memory of each of said individual echo signal generating units;
an image mixer for receiving the plural echo signals read out from the plurality of first image memories and determining display colors based on combinations of the levels of the echo signals obtained from the same locations;
an image data converter for generating display data by converting the echo signals into the display colors determined by said image mixer; and
a display for presenting the display data generated by said image data converter.

8. The radar system according to claim 7 further comprising a second image memory for storing the echo signal obtained from each successive antenna rotation in the form of a radar image; and
an imaging controller for reading out the echo signals stored in said first image memories in synchronism with rotations of the antennas of said individual echo signal generating units;
wherein said second image memory is used as a buffer for generating the display data from the echo signals read out from said first image memories.

9. The radar system according to claim 8, wherein each of said echo signal generating units includes a scan-to-scan correlator for performing a scan-to-scan correlation process on the echo signal, wherein said image mixer determines the display colors by using results of the scan-to-scan correlation process.

10. The radar system according to claims 7, wherein said start point setters determine the imaging start addresses based on installation sites of the antennas of said individual echo signal generating units.

11. The radar system according to claims 7, wherein said image mixer classifies the combinations of the levels of the echo signals into a predetermined number of groups and selects display colors for the individual groups.

12. The radar system according to claims 7, wherein said image mixer classifies the combinations of the levels of the echo signals into a predetermined number of groups according to the number of the echo signals to be mixed and selects display colors for the individual groups as well as shades of each display color according to the levels of the echo signals to be mixed.

13. A radar system comprising:
an antenna for transmitting a pulse signal including pulses having at least two different pulselengths according to a specified transmit pulse pattern;
a receiver block for generating an echo signal from a reflected radio wave received by said antenna;
an A/D converter for converting the echo signal from an analog form into a digital form;
a distributor separating the echo signal output from said A/D converter into at least two echo signals obtained with the individual pulselengths and separately outputting the echo signals;
a plurality of sweep memories for storing the separately distributed echo signals in real time;
a plurality of first image memories for storing the echo signals for the individual pulselengths separately output from said sweep memories in the form of radar images;
an start point setter for generating imaging start addresses from where the echo signals for the individual pulselengths are to be written in said first image memories;
an address generator for generating write addresses indicating where the echo signals for the individual pulselengths are to be written in said first image memories based on the transmit pulse pattern of the transmitted pulses having the different pulselengths;
a display controller for controlling readout timing of the echo signals for the individual pulselengths stored in said first image memories;
an image mixer for receiving the echo signals for the individual pulselengths read out from said first image memories and determining display colors based on combinations of the levels of the echo signals obtained from the same locations;
an image data converter for generating display data by converting the input echo signals into the display colors determined by said image mixer; and
a display for presenting the display data generated by said image data converter.

14. The radar system according to claim 13 further comprising a plurality of scan-to-scan correlators for separately performing a scan-to-scan correlation process on the echo signals for the individual pulselengths, wherein said image mixer determines the display colors by using results of the scan-to-scan correlation process.

15. The radar system according to claims 13, wherein said image mixer classifies the combinations of the levels of the echo signals into a predetermined number of groups and selects display colors for the individual groups.

16. The radar system according to claims 13, wherein said image mixer classifies the combinations of the levels of the echo signals into a predetermined number of groups according to the number of the echo signals to be mixed and selects display colors for the individual groups as well as shades of each display color according to the levels of the echo signals to be mixed.
